(19) United States
(12) Patent Application Publication
(10) Pub. No.: US 2006/0054085 A1
(43) Pub. Date: Mar. 16, 2006

(54) Simplified powder fluidization apparatus and method

(76) Inventor: Michael R Sanner, Amherst, OH (US)

Correspondence Address: CALFEE, HALTER & GRISWOLD, LLP, 800 SUPERIOR AVENUE, SUITE 1400, CLEVELAND, OH, 44114, US

(21) Appl. No.: 10/514,853

(22) PCT Filed: Apr. 4, 2003
(86) PCT No.: PCT/US03/10217

§ 371 Date: Nov. 12, 2004

Related U.S. Application Data
(60) Provisional application No. 60/380,244, filed on May 13, 2002.

(51) Int. Cl. B05C 11/00

(52) U.S. Cl. 118/612

(57) ABSTRACT

Fluidizing device that is structurally separate from a powder container (12) includes a housing (100) that defines an interior air volume and a portion of the housing is porous or permeable to air flow. The housing (100) is coupled to a source of air (104) and produces a distributed fluidization air flow (102) within the container (12). The device may be introduced into the container (12) either before, after or coincident with the introduction of powder into the container (12). The device can be easily removed from the container (12) for replacement, cleaning or as part of a color change operation.

### RELATED APPLICATION

This application claims the benefit of U.S. Provisional patent application Ser. No. 60/380,244 filed on May 13, 2002 for SIMPLIFIED FLUIDIZATIONS SYSTEM, the entire disclosure of which is fully incorporated herein by reference.

### TECHNICAL FIELD OF THE INVENTION

The present invention relates generally to fluidizing powder coating material. More particularly, the invention relates to apparatus and methods for fluidizing powder coating material with a fluidizing device that can be separately installed into a powder container.

### BACKGROUND OF THE INVENTION

Powder spraying systems are well known. A typical powder spraying system includes a powder supply, such as powder stored in a fluidizing hopper. The powder in the hopper may be fluidized using pressurized air, although not all powder spray systems use fluidized powder supplies. The spraying system also includes a powder spray device such as a spray gun that extends into a spray booth. The spray gun is used to spray powder at an object inside the booth. The spray booth is used for powder containment and recovery. Many types of spray guns have been developed over the years including electrostatic guns such as corona spray guns and tribo-charging guns. Most powder spraying systems also include a powder collection system to collect powder overspray. Some powder spraying systems use non-electrostatic spray guns.

Powder is typically pumped from the hopper to the spray gun using a Venturi powder pump that is attached to the top end of a powder pick-up tube. The powder pick-up tube extends down into the hopper and operation of the pump draws fluidized powder into the pick-up tube and then forces the powder under positive pressure to the spray gun via a powder feed hose attached to a powder outlet of the pump. Fluidizing the powder in the hopper facilitates the removal of powder from the hopper through the pick-up tube.

Fluidizing hoppers include a powder container section and a fluidizing drum. An air fitting interfaces with the fluidizing drum interior, typically through a wall of the drum. The fluidizing drum is separated from the powder container section by a porous plate. The porous plate is sealed between the drum and the container section with a gasket or seal arrangement. The hopper also is typically made of expensive stainless steel. The hopper when assembled is difficult to clean especially for a color change because it must be disassembled to remove the porous plate. The gasket must often be replaced as well.

The need exists therefore for an improved fluidizing arrangement that is easier to clean and lower in cost than a conventional fluidizing hopper.

### SUMMARY OF THE INVENTION

The present invention contemplates apparatus and methods for fluidizing powder coating material by using a fluidizing device that is structurally separate from a powder container. In accordance with one aspect of the invention, a fluidizing device is introduced into a container that holds a supply of powder coating material. The fluidizing device can be introduced into an interior volume of a powder container either before, after or coincident with the introduction of powder into the container. With the fluidizing device structurally separate from the container, it can easily be removed from the container as part of a color change or cleaning operation. In one embodiment, an apparatus for fluidizing powder coating material includes a powder container and a fluidizing device adapted to be removably positioned in the container, wherein the fluidizing device produces an air flow to fluidize powder in the container when pressurized air is provided to the fluidizing device.

In an exemplary embodiment of a fluidizing device, such a device includes a housing defining an air volume; the housing having at least a portion thereof comprising porous material through which air can flow; the housing having a pressurized air inlet to the air volume. The present invention thus further contemplates the fluidizing device as a distinct aspect of the invention that may be used with any type of powder container including, but not limited to, a drum, hopper, box, bag, can and so on. The container defines an interior volume into which powder coating material may be introduced. Moreover, the invention contemplates that the porous material may take different forms including porous plastics, meshes, screens, fabric, foam, porous stone, perforated materials and so on.

In accordance with another aspect of the invention, a fluidizing device may be realized in many different configurations besides the above mentioned embodiment. For example, but not by way of limitation, the fluidizing device may be in the form of one or more disks, rods, spheres, rings or hoses to name a few examples.

In accordance with another aspect of the invention, a fluidizing device is positioned within a powder container so as to fluidize a portion of the powder contained therein that is withdrawn by a powder pick-up tube that extends into the powder container. In one embodiment, an apparatus for fluidizing powder coating material includes a powder container, a fluidizing device that can be introduced into an interior volume of the container and removable therefrom, and a powder pick-up tube supported so as to extend into the container. In another embodiment the pick-up tube is connected with a powder pump that draws powder from the container and feeds it to a spray gun via a powder feed hose or another container/receptacle.

The invention further contemplates, in addition to the methods embodied in the operation of the various embodiments herein, a method for fluidizing powder coating material, the method including the steps of introducing powder coating material into the interior volume of a container, introducing a fluidizing device into the interior volume of the container, and providing pressurized air to the fluidizing device to fluidize the air in the container.

These and other aspects and advantages of the present invention will be apparent to those skilled in the art from the following description of the preferred embodiments in view of the accompanying drawings.

### BRIEF DESCRIPTION OF THE DRAWINGS

The invention may take physical form in certain parts and arrangements of parts, preferred embodiments and methods of which will be described in detail in this specification and illustrated in the accompanying drawings which form a part hereof, and wherein:

FIG. 1 is a simplified schematic of a fluidizing apparatus in accordance with the invention;

FIG. 2 is another embodiment of the apparatus of FIG. 1 illustrated in more detail;

FIG. 3 is an elevation in vertical cross-section of a fluidizing device in accordance with the invention;

FIGS. 4-9 illustrate in plan view various exemplary alternative embodiments of the configuration of a fluidizing device in accordance with the invention; and

FIGS. 10-12 illustrate another embodiment of a fluidizing device in accordance with the invention.

### DETAILED DESCRIPTION OF THE INVENTION

The present invention is directed to methods and apparatus for fluidizing powder coating material. A basic aspect of the invention is a fluidizing device that is structurally separate or independent from a powder coating material container. The fluidizing device in combination with a powder container may be used in a powder application system to transfer powder from the container to either an application device such as a spray gun or another powder container.

Although various preferred, exemplary and alternative embodiments of the invention are described herein, such descriptions are not intended to be an exhaustive list of such alternatives and options. Additional alternatives and modifications will be readily apparent to those skilled in the art within the spirit and scope of the present invention.

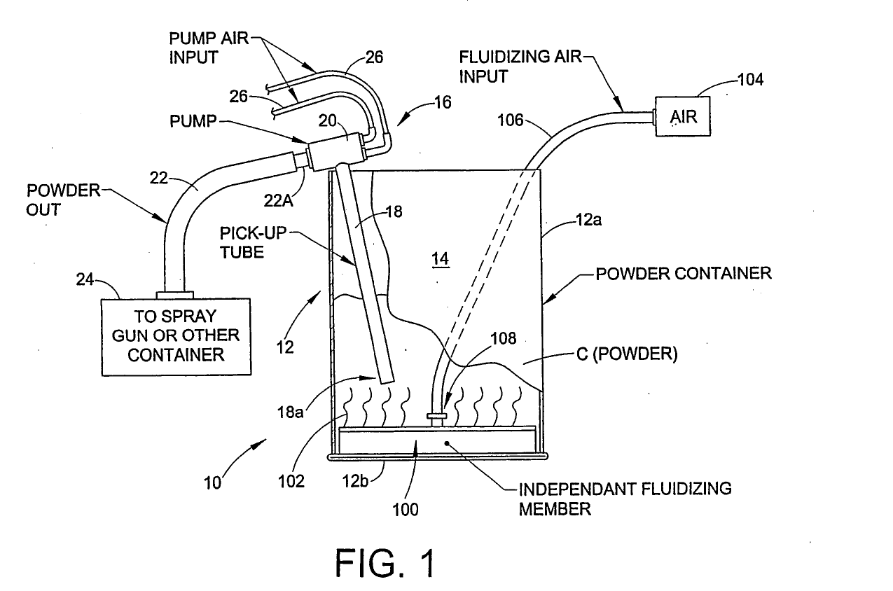

With reference to FIG. 1, a powder fluidization system 10 includes a powder container 12 having a generally cylindrical profile with a cylindrical wall portion 12a and a bottom 12b, generally in the shape of a drum. A top (not shown) may be provided if required. Although a cylindrical container 12 is illustrated in the embodiments herein, the present invention is not limited to any particular container form or configuration. To the contrary, the present invention facilitates the ability to fluidize powder with virtually any powder container configuration, including but not limited to a drum, box, bag, hopper and so on. This aspect of the invention is facilitated by the use of a fluidizing device that is not structurally integral with the container (although if need be the fluidizing device could be attached or otherwise removably mounted with the container.) An optional vibrator (not shown) may be used with the container to facilitate fluidization of the powder by minimizing dead zones or accumulations of powder outside the fluidization zone of the fluidization device.

The container 12 defines an interior volume 14 into which powder coating material C is introduced. The powder C may be introduced into the container in any convenient fashion, including but not limited to manually dumping the powder from a bag to the container 12, transferring powder from another container into the fluidizing container 12, or simply using a powder container such as a bag that is used to ship the powder from the powder supplier to the powder user.

The fluidization system 10 further includes a powder transfer apparatus 16 which in this example includes a powder pick-up tube 18, a powder pump 20 and a powder feed hose 22 that is connected at one end 22a to the outlet of the pump 20 and at another end to a downstream spray gun, applicator or another receptacle 24. The pump 20, pick-up tube 18, powder feed hose 22 and downstream apparatus 24 may be conventional and are well known to those skilled in the art. The pump 20 typically includes, for example, one or more air lines 26. The pick-up tube 18 is positioned so as to extend into the container 12 interior volume 14. Typically the distal end 18a of the pick-up tube is positioned near or at the bottom of the container 12. In accordance with one aspect of the invention, one or more pick-up tubes 18 may be used in association with the container 12, with the tubes being inserted so as to withdraw powder from the container in a vicinity of an associated fluidizing device 100. This is particularly useful for large containers, such as conventional hoppers. In the embodiment of FIG. 1 there is only one fluidizing device 100 because it is large enough to fluidize the powder in the container 12.

Completing the description of FIG. 1, a fluidizing device 100 is provided, typically at the bottom of the container 12 within the volume 14 of the container. The fluidizing device 100 in its simplest form is a device that is preferably structurally separate or independent from the structure of the container 12, in the sense that the fluidizing device 100 can be easily introduced into and removed from the container 12. The fluidizing device 100 produces a generally distributed air flow 102 (represented in an exemplary manner by wavy lines 102 in the drawings without intending to imply any particular air flow pattern) into the powder C that generally surrounds or is in the vicinity of the fluidizing device 100. The fluidizing device receive pressurized air or an air flow from an air source 104 via an air line or hose 106. The air line 106 is coupled to the fluidizing device 100 via an appropriate fitting 108.

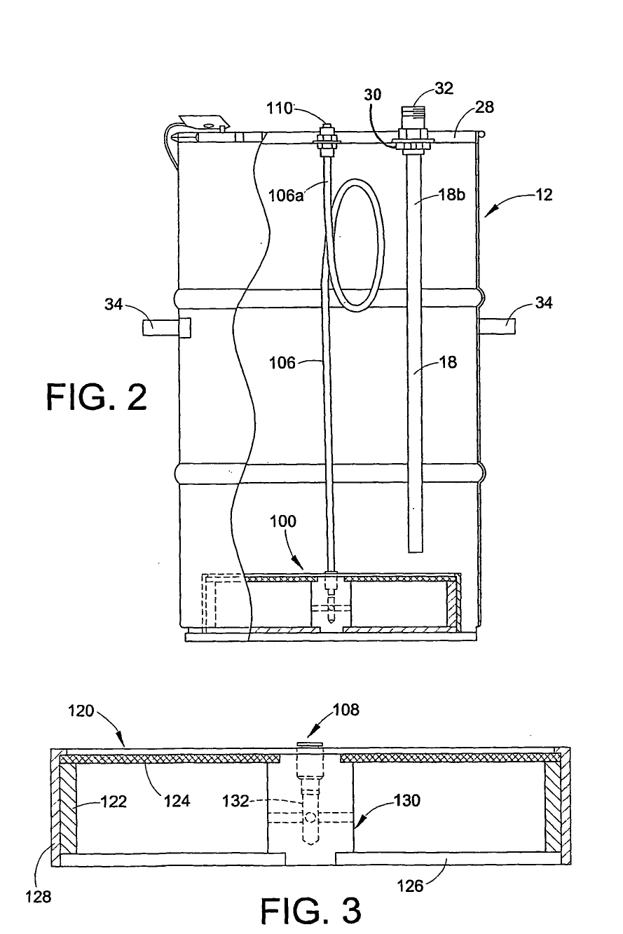

FIG. 2 illustrates another embodiment in more detail without the pump 20 installed. In this example, the container 12 is a conventional drum, such as, for example, a basic steel drum commercially available from a number of drum manufacturers. The container 12 includes a removable lid or cover 28 that supports an upper end 18b of the pick-up tube 18 such as with a nut 30 and fitting 32. The fitting 32 may be threaded to receive the pump 20, or a slip fit may be used, for example. An upper end 106a of the air line 106 may also be mounted to the lid 28, with an appropriate fitting 110 to receive one end of an air hose (not shown). Handles 34 may be provided on the container 12 for easier movement of the container 12 within a facility. A grounding strap (not shown) may be used to electrically ground the container 12.

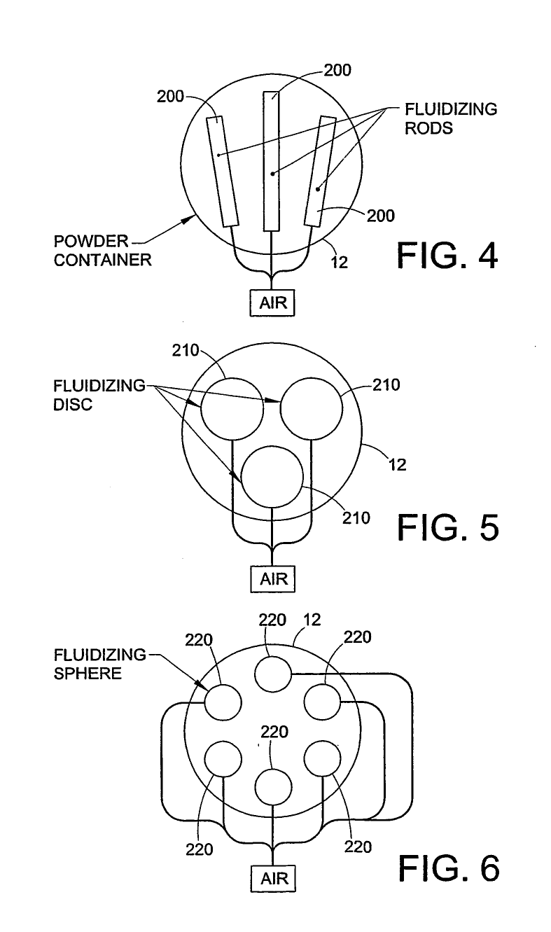

FIG. 3 illustrates an exemplary embodiment of the fluidizing device 100. In this example, the device 100 includes a housing 120 which may be molded or otherwise formed as an integral unit, or as illustrated may be a multi-piece construct. The housing 120 includes a generally cylindrical inner support body 122, such as a section of PVC pipe or other appropriate material. The device 100 need not be round or cylindrical in shape, but may take on any desired shape to effect the desired air flow pattern to fluidize the powder. The inner support 122 is closed on one side with a fluid plate in the form of a porous or air permeable cover member 124 and on an opposite side with a bottom plate 126 to form a flattened disc or can-like structure. An optional outer support member 128 may be used to rigidly hold the inner member 122, fluid plate 124 and bottom plate 26 together. An appropriate adhesive may also be used to form a rigid sealed enclosure. In one embodiment, the outer support member 128 may be a split member in order to permit ease of assembly of the inner support member 122, the cover 124 and the bottom plate 126. The outer member 128 may then be radially compressed during the final assembly with adhesive so as to form the final structure. Many other techniques for manufacturing and assembling the fluidizing device will be readily apparent to those skilled in the art.

Although the fluid plate 124 is made of the porous material, those skilled in the art will readily realize that different parts of the device 100 may also be made of porous or air permeable material depending on the fluidization desired. The porous material may take different forms including porous plastics, meshes, screens, fabric and so on. In an exemplary embodiment the material comprises porous polyethylene. Any feasible material or structure may be used to render part or all of the fluidizing device 100 porous or permeable to a flow of air therethrough. Preferably, the porous material will allow air to pass but resist allowing powder particles to either enter the housing 120 or to clog the material so as to reduce the flow of air. Periodically as required the fluidizing device 100 may be removed from the container 12 for cleaning or replacement.

Preferably although not necessarily centrally positioned in the device 100 is an air inlet boss 130. The boss 130 includes the air line fitting 108 which communicates with an air passage 132. Air from the source 104 (FIG. 1) flows into the interior volume of the fluidizing device 100 and under pressure will tend to flow through the porous material in a distributed fluidizing air pattern.

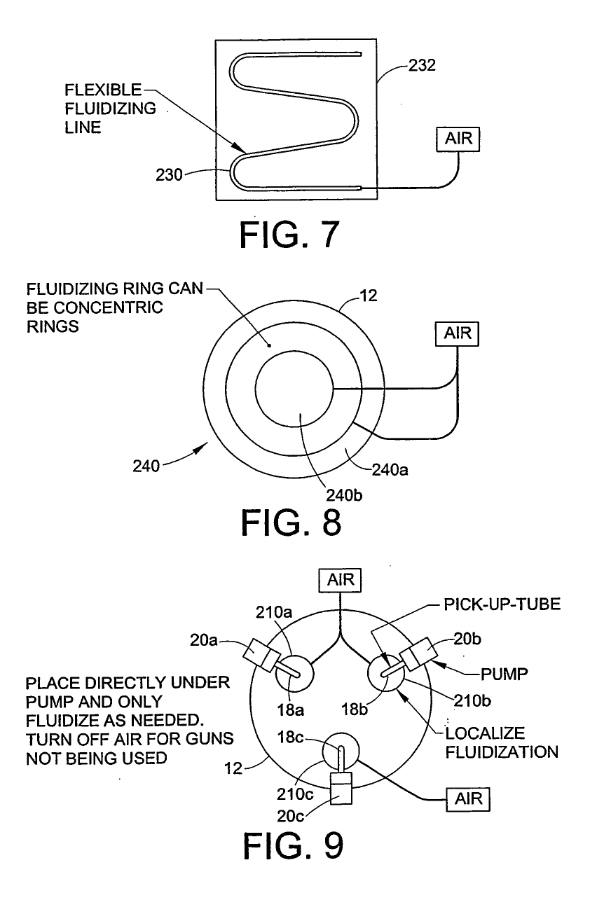

With reference to FIGS. 4-9 many different configurations for the fluidization device 100 may be used, and many others will be readily attainable by those skilled in the art. Note that in these figures the view is as if from the top of the container 12 looking down into the container at the layout or position of the fluidizing devices. These layouts are merely exemplary in nature and may be varied as required. Additionally, various of the options may be used together if so desired. Furthermore, although the illustrated embodiments herein provide regular geometric shapes for the fluidizing device, the designer may choose to also make the fluidizing device in any irregular shape.

In these various embodiments, the designer may select which portions of the fluidizing device structure are to be permeable or porous to air flow to achieve a desired fluidization air flow. In the embodiment of FIG. 4, a series of either tubular or rectangular or other geometrically shaped rods 200, each of which is coupled to an air source that supplies the fluidizing air such as the source 104 (FIG. 1). In FIG. 5 the fluidizing device 210 is realized in the form of a disk, however the shape may also be oval for example or any other suitable shape. In FIG. 6 the fluidizing device 220 is in the form of a sphere, but again many different geometric shapes may be used, such as a football shape to name but one example. In FIG. 7 a fluidizing device 230 is provided that is useful for a rectangular powder container 232. It should be noted that in accordance with the invention, the geometric shape of the fluidizing device may be selected based on the particular shape of the container in which it will be used, and furthermore, some containers such as bags may not have a rigid or uniform shape. In the embodiment of FIG. 7, a flexible fluidizing line 230 such as a porous hose may be provided that can be selectively arranged within the container 232 to effect a desired fluidization flow pattern. Alternatively the device 230 may be made in separate segments. In FIG. 8, the fluidizing device 240 is formed as two concentric rings 240a and 240b. In the embodiment of FIG. 9, a plurality of fluidizing devices 210a, b, c, in this example the fluidizing discs 210 of FIG. 5, are appropriately positioned within the container 12 so that the fluidization zone is in the vicinity of a respective pick-up tube 18a, b, c. and pump 20a, b, c. This is especially useful in large containers 12 where a plurality of pumps may extract the powder for separately used application devices. In this example, a fluidizing disc need only be pressurized if its associated pump is activated.

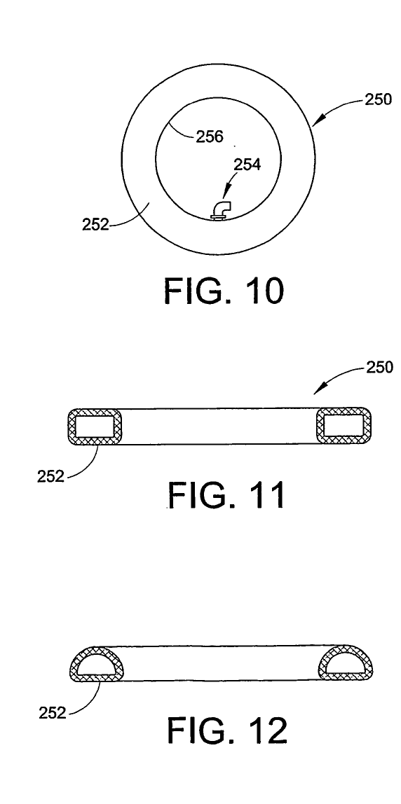

FIGS. 10-12 illustrate another embodiment of the fluidizing device. In this example, the fluidizing device 250 is somewhat donut shaped, but may also be a toroid or other regular or irregular shape. The fluidizing device 250 includes a hollow ring 252 such as can be molded from a suitable porous material. A suitable air line fitting 254 may be provided in the inside perimeter 256 if it is desired to size the device 250 so that the outer perimeter is near the container wall. If such is not the case, the fitting 254 may be disposed on the outer perimeter of the device 250, or anywhere else along the surface of the device 250. The cross-sectional shape of the ring 252 in the case of FIG. 11 is a rectangle, but could also be round, half round as shown in FIG. 12 or any other suitable shape.

The present invention also contemplates methods for fluidizing powder in a container. These methods include but are not limited to the methods embodied in the use or operation of the above-described embodiments of the fluidizing devices. The invention further contemplates a method for fluidizing powder in which powder is introduced into a container, a fluidizing device is introduced into the container, and air is provided to the fluidizing device to produce a fluidizing air flow to fluidize the powder in the container. The fluidizing air flow may be uniformly distributed within the container or may be non-uniform depending on the fluidization required. The fluidizing device can be introduced into an interior volume of a powder container either before, after or coincident with the introduction of powder into the container. The container may also be vibrated as part of the fluidization process to facilitate better fluidization of the powder. The fluidizing device may be removed and exchanged or cleaned as part of a maintenance process or a color change operation.

The invention has been described with reference to the preferred embodiment. Modifications and alterations will occur to others upon a reading and understanding of this specification. It is intended to include all such modifications and alterations insofar as they come within the scope of the appended claims or the equivalents thereof.

Having thus described the invention, it is claimed:

1. Apparatus for fluidizing powder coating material, comprising:
a powder container and a fluidizing device adapted to be removably positioned in said container, said fluidizing device producing an air flow to fluidize powder in said container when pressurized air is provided to said fluidizing device.

2. The apparatus of claim 1 wherein said fluidizing device produces a distributed air flow.

3. The apparatus of claim 1 comprising two or more said fluidizing devices.

4. The apparatus of claim 3 wherein said fluidizing devices are positioned to fluidize respective portions of powder in said container corresponding to respective powder pick-up tubes.

5. The apparatus of claim 1 comprising a powder pick-up tube insertable into said container.

6. The apparatus of claim 1 wherein said powder container comprises a drum.

7. The apparatus of claim 1 wherein said fluidizing device comprises a housing that receives pressurized air; said housing having a porous wall through which fluidizing air exits said housing into said powder container interior.

8. The apparatus of claim 7 wherein said porous wall is an upper wall of a cylindrical housing.

9. The apparatus of claim 8 wherein said porous material comprises polyethylene.

10. The apparatus of claim 7 wherein said fluidizing device is in a from selected from the following group: sphere, rod, disc, ring and hose.

11. The apparatus of claim 1 comprising a pick-up tube insertable into said powder container, a powder pump associated with said pick-up tube, a powder feed hose connectable to an outlet of said powder pump and a powder spray gun connectable to said powder feed hose.

12. Apparatus for fluidizing powder coating material, comprising:
a powder container; and
a fluidizing device that receives pressurized air and produces an air flow to fluidize powder in said container, said fluidizing device being structurally separate and removable from said powder container.

13. The apparatus of claim 12 wherein said fluidizing device produces a distributed air flow.

14. The apparatus of claim 12 comprising two or more said fluidizing devices.

15. The apparatus of claim 14 wherein said fluidizing devices are positioned to fluidize respective portions of powder in said container corresponding to respective powder pick-up tubes.

16. The apparatus of claim 12 comprising a powder pick-up tube insertable into said container.

17. The apparatus of claim 12 wherein said powder container comprises a drum.

18. The apparatus of claim 12 wherein said fluidizing device comprises a housing that receives pressurized air; said housing having a porous wall through which fluidizing air exits said housing into said powder container interior.

19. The apparatus of claim 18 wherein said porous wall is an upper wall of a cylindrical housing.

20. The apparatus of claim 19 wherein said porous material comprises polyethylene.

21. The apparatus of claim 18 wherein said fluidizing device is in a form selected from the following group: sphere, rod, disc, ring and hose.

22. The apparatus of claim 12 comprising a pick-up tube insertable into said powder container, a powder pump associated with said pick-up tube, a powder feed hose connectable to an outlet of said powder pump and a powder spray gun connectable to said powder feed hose.

23. A powder fluidizing device comprising a housing defining an air volume; said housing having at least a portion thereof comprising material through which air can flow; said housing having a pressurized air inlet to said air volume.

24. The device of claim 23 wherein said material comprises a porous material.

25. The device of claim 24 wherein said material comprises porous polyethylene.

26. The device of claim 23 wherein said material is selected from the following group: porous plastics, meshes, screens, fabric.

27. The device of claim 23 wherein said housing comprises a cylindrical wall, a first plate and a porous plate assembled to form an enclosed air volume.

28. The device of claim 23 comprising an air inlet device in fluid communication with said air volume.

29. A method for fluidizing powder coating material, comprising the steps of:
placing powder coating material into a container;
positioning a fluidizing device into the container;
providing pressurized air to the fluidizing device to fluidize the air in the container.

30. The method of claim 29 wherein said step of placing the fluidizing device in the container is done with powder coating material already in the container.

31. The method of claim 29 comprising the step of removing the fluidizing device from the container as part of a color change operation.

32. Apparatus for fluidizing powder coating material, comprising:
a powder container that defines an interior volume; and
a fluidizing device that receives pressurized air and produces an air flow to fluidize powder in said container, said fluidizing device being removably introduced within said powder container volume.

33. A method for fluidizing powder coating material, comprising the steps of:
introducing powder coating material into the interior volume of a container;
introducing a fluidizing device into the interior volume of the container;
providing pressurized air to the fluidizing device to fluidize the air in the container.

34. The apparatus of claim 1 wherein said container is selected from the following group: bag, drum, box, hopper.
